(19) United States
(12) Patent Application Publication
(10) Pub. No.: US 2009/0314725 A1
(43) Pub. Date: Dec. 24, 2009

(54) APPARATUS AND METHOD FOR COLLECTING A TARGET FLUID SUBMERGED IN A HIGHER DENSITY CARRIER FLUID

(75) Inventor: TJ Parro, Woodbury, MN (US)

Correspondence Address: HAMRE, SCHUMANN, MUELLER & LARSON, P.C., P.O. BOX 2902, MINNEAPOLIS, MN, 55402-0902, US

(73) Assignee: WINDSOR INNOVATIONS, LTD., WOODBURY, MN (US)

(21) Appl. No.: 12/307,407

(22) PCT Filed: Jul. 18, 2007
(86) PCT No.: PCT/US07/73774

§ 371 Date: Jan. 5, 2009

Related U.S. Application Data
(60) Provisional application No. 60/831,777, filed on Jul. 19, 2006.

(51) Int. Cl. B01D 11/04; C02F 1/40

(52) U.S. Cl. 210/800; 210/242.1; 210/523; 210/241

(57) ABSTRACT

Apparatus and method for collecting a target fluid submerged in a carrier fluid when the specific gravity of the target fluid is lower than the specific gravity of the carrier fluid and the target fluid is essentially immiscible with the carrier fluid. The apparatus includes a funnel, a system effective for achieving submersion of a majority of the slant height of the funnel within the carrier fluid, and a pump in fluid communication with the interior volume of the funnel proximate the smaller end of the funnel for pumping fluid collected at the smaller end of the funnel. The method involves positioning a funnel between the submerged target fluid and the upper surface of the carrier fluid so as to catch and direct an upward flow of the target fluid towards the smaller end of the funnel before the target fluid reaches the upper surface of the carrier fluid.

### BACKGROUND

Governments and industry spend billions of dollars every year worldwide recovering from incidents of contaminant spills in fresh and salt bodies of water. The result of chemical spills on the ecosystem is costly and long term in duration. Cleanup costs of waterways and shorelines are manpower intensive and costly as well. Communities, industries, and governments lose revenue as a result of such incidents, which also have a negative impact on animal and human health.

Current technologies address the recovery of oil and other contaminants from bodies of water by employing surface barriers for containment after the contaminant has risen to the surface, and utilizing skimmers for removal of the contaminant within and without the barrier area from the surface of the water. Absorbent materials are used to further contain and mitigate the damage due to a spill. These absorbent materials are dispersed in a variety of different manners and must also be removed as part of the cleanup process. Together, these mechanisms and methods of containment, collection and cleanup are utilized to recover the ecosystem and mitigate the negative impact of a contaminant spill in bodies of water.

The current art collects and removes the contaminant only after the contaminant has reached the surface and the shoreline. Such a recovery process is difficult and expensive as wind and water currents often spread the contaminant over a vast area before the contaminant reaches the surface for recovery. Accordingly, a substantial need exists for an apparatus and method for recovering contaminants from a body of water without having to wait for the contaminant to reach the surface of the water or a shoreline.

### SUMMARY OF THE INVENTION

A first aspect of the invention is an apparatus for collecting a target fluid submerged in a carrier fluid when the specific gravity of the target fluid is lower that the specific gravity of the carrier fluid and the target fluid is essentially immiscible with the carrier fluid. The apparatus includes (i) a funnel having a slant height, a larger end and a smaller end, (ii) a system effective for achieving submersion of a majority of the slant height of the funnel within the carrier fluid, and (iii) a pump in fluid communication with the interior volume of the funnel proximate the smaller end of the funnel for pumping fluid collected at the smaller end of the funnel.

A second aspect of the invention is a method for collecting a target fluid submerged in a carrier fluid when the carrier fluid defines an upper surface, the specific gravity of the target fluid is lower that the specific gravity of the carrier fluid, and the target fluid is essentially immiscible with the carrier fluid. The method comprises the step of positioning a funnel between the submerged target fluid and the upper surface of the carrier fluid so as to catch and direct an upward flow of the target fluid towards the smaller end of the funnel before the target fluid reaches the upper surface of the carrier fluid.

### BRIEF DESCRIPTION OF THE DRAWINGS

FIG. 1 is an upper perspective view of one embodiment of a collector according to the invention with a right conical funnel deployed over a leaking sunken oil tanker and positionally stabilized by a plurality of anchors.

FIG. 2 is an upper perspective view of the collector shown in FIG. 1 with a right pyramidal funnel deployed over a leaking sunken oil tanker.

FIG. 3 is an upper perspective view of the collector shown in FIG. 1 with a right hexahedron funnel deployed over a leaking sunken oil tanker.

FIG. 4 is an upper perspective view of the collector shown in FIG. 1 with a hemispherical funnel deployed over a leaking sunken oil tanker.

FIG. 5 is an upper perspective view of the collector shown in FIG. 3 with the funnel canted to face the larger end of the funnel towards the prevailing current.

FIG. 6 is an upper perspective view of a second embodiment of the funnel portion of a collector in accordance with the invention positionally stabilized with ballast.

FIG. 7 is an upper perspective view of a third embodiment of the funnel portion of a collector in accordance with the invention positionally stabilized with ballast.

FIG. 8 is a top view of the funnel portion of the collector shown in FIG. 7.

FIG. 9 is a bottom view of the funnel portion of the collector shown in FIG. 7.

FIG. 10 is an upper perspective view of a second embodiment of a collector according to the invention with a right hexahedron funnel deployed over a leaking sunken oil tanker and positionally stabilized with magnetic ballast.

FIG. 11 is an upper perspective view of a plurality of the collectors shown in FIG. 3 deployed as an array above a separated sunken oil tanker and stabilized by a single central anchor.

FIG. 12 is a top view of the funnel portion of the array of collectors shown in FIG. 11.

### DETAILED DESCRIPTION OF A PREFERRED EMBODIMENT

### Nomenclature

10 Collector
20 Funnel
21 Larger End of Collector (Base)
22 Smaller End of Collector (Top)
30 Extraction Pipe
40 Buoy
45 Buoy Tie Line
49 Buoy Anchor
50 Anchors
55 Anchor Tie Lines
60 Solid Ballast
70 Erection System
71 Hub
72 Spokes
73 Pressurized Fluid Feed Line
80 Reclamation Vessel
90 Pump
100 Source of Submerged Target Fluid (Oil Tanker)
101 Target Fluid
102 Carrier Fluid

### Underlying Principles

The apparatus and method of this invention applies the Archimedes' principle, which states that a body immersed in a fluid is buoyed up by a force equal to the weight of the displaced fluid. The principle applies to both floating and submerged bodies and to all fluids (i.e., liquids and gases). It explains the buoyancy of ships and other vessels in water, the rise of a balloon in the air and the buoyancy of fluids having a relative density less than that of the fluid in which it is suspended. When two or more fluids compete for the same space, gravitational forces the fluid having the greatest density to be drawn closest to the source of gravity, thereby displacing those fluids of lower density.

The present invention method and apparatus applies the Archimedes' principle for the in-fluid and sub-surface collection, separation, and removal of oil or other fluids essentially immiscible in and having a relative density less than that of a fluid in which it is suspended.

As utilized herein, including the claims, the phrases “essentially immiscible”, “generally immiscible” and “substantially immiscible” refer to liquids that are insoluble or nearly insoluble in one another so as to be incapable of reaching homogeneity when combined, such that they remain as separately identifiable masses when mixed.

### General Aspects

The present invention relates generally to an apparatus and method for collecting and removing a target fluid that is generally immiscible in and has a specific gravity less than a carrier fluid in which it is suspended. For illustration purposes only and without intending to be limited thereby, the invention will be described in connection with crude oil (the target fluid) leaking from a sunken tanker into the ocean (the carrier fluid).

One aspect of the invention provides a collector and method of in-fluid and subsurface collection of a target fluid having a lower specific gravity (the target fluid) suspended in a carrier fluid having a greater specific gravity (the carrier fluid).

The present invention also provides for a collector and method for collection of a target fluid having a lower specific gravity that is dispersing into a carrier fluid.

The present invention provides a collector and method for collection of a target fluid having a lower specific gravity in a body of a carrier fluid that may be characteristically large and deep, such as an ocean.

The present invention provides a collector and method for collection of a fluid of a lower specific gravity in a body of carrier fluid that has flow characteristics such as an ocean and a river.

The present invention also provides for a collector and method for collection of a fluid of a lower specific gravity in a body of a carrier fluid when both fluids are a gas.

The present invention also provides for a collector and method for collection of a target fluid of a lower specific gravity in a body of a carrier fluid wherein the target fluid is a gas.

Another aspect of the invention provides for a collector having a wider area at the base and a smaller are at its apex.

Another aspect of the invention provides for collectors and methods to connect a plurality of collectors to form a greater area of collection of a target fluid having a lower specific gravity from a carrier fluid having a higher specific gravity.

Another aspect of the invention provides for collectors and methods to connect a plurality of collectors wherein the base may be hexagonal and the straight edges of the base on two or more collectors may be connected to one another as necessary to cover an ever increasing area.

Another aspect of the invention provides for collectors and methods to connect a plurality of collectors wherein each section of the collector may be a truncated pyramid and the individual pyramid shapes may be coupled to one another as necessary to cover an ever increasing area.

Another aspect of the invention provides for a collector and method to deploy the collector below the surface of a body of carrier fluid.

By way of example, but not limited hereto, the collector may be (i) folded in an accordion form for purpose of storage, stowage and transportation, (ii) deployed below the surface of the carrier fluid in accordion form, and (iii) once submerged and stabilized in the proper location and appropriate orientation, unfolded into a deployed form by means of wenches attached to the floatation and orientation anchoring buoys.

A further example, but not limited hereto, the collector may be (i) folded in an accordion form for purpose of storage, stowage and transportation, (ii) deployed below the surface of the carrier fluid in accordion form, and (iii) once submerged and stabilized in the proper location and appropriate orientation, unfolded into a deployed form by pumping a ballast fluid having a density equal to or greater than the density of the carrier fluid into ribs forming part of the funnel on the collector.

Another aspect of the invention provides for a collector and method to orient the deployed the collector below the surface of a carrier fluid near a source of the target fluid having a lower specific gravity, to maximize collection of the target fluid by capturing the target fluid prior to significant dispersal of the target fluid in the carrier fluid.

Another aspect of the invention provides for a collector and method to appropriately orient the deployed the collector below the subsurface of a carrier fluid that is flowing, to maximize collection of the target fluid by capturing the target fluid prior to significant dispersal of the target fluid in the carrier fluid.

Another aspect of the invention provides for a collector and method to maintain buoyancy of the collector by the use of floatation devices such as buoys to which it is attached.

Another aspect of the invention provides for a collector and method to buoy the base of the collector at the specified submerged depth and properly orient the collector by using floatation material attached to the apex of the funnel proximate the surface of the carrier fluid.

Another aspect of the invention provides for a collector and method to retain a desired orientation of the deployed collector by attaching the funnel to anchored buoys.

Another aspect of the invention provides for a collector and method to buoy the collector at the specified submerged depth and oriented position by attaching flotation devices, such as buoys, to the funnel.

Another aspect of the invention provides for a collector and method to retain a desired position and orientation of a deployed collector by anchoring the collector to the floor of the body of carrier fluid.

Another aspect of the invention provides for a collector and method to retain a desired position and orientation of a deployed collector by utilizing wenches attached at intervals about the base of the funnel for changing the length of one or more anchor ties to compensate for repositioning of the funnel caused by changes in the flow pattern of the carrier fluid.

Another aspect of the invention provides for a collector and method to retain a desired position and orientation of a deployed collector by directly anchoring the funnel to the source of the target fluid having a lower specific gravity. A nonlimiting example of a system for achieving such direct anchoring comprises magnetic grapples capable of magnetically attaching the metal hull of a sunken ship.

Yet another aspect of the invention provides for removal of collected target fluid having a lower specific gravity from the funnel.

A further aspect of the invention provides for the synchronous collection and removal of a target fluid having a lower specific gravity using the collector.

Another aspect of the invention provides for a collector having a funnel with an access opening proximate the smaller end or apex of the funnel for permitting removal of collected target fluid having a lower specific gravity amassed within the funnel.

Another aspect of the invention provides for a collector wherein the apex of the funnel may be oriented in such a manner that the smaller end or apex of the funnel extends above the surface of the carrier fluid.

Another aspect of the invention provides for a collector wherein the smaller end or apex of the funnel may be in fluid communication with another reservoir such that target fluid amassed within the funnel may be directed from the funnel into the another reservoir for storage.

Another aspect of the invention provides for a collector wherein the smaller end or apex of the funnel provides an interface for allowing removal of target fluid amassed within the funnel.

Another aspect of the invention provides for a collector wherein the smaller end or apex of the funnel provides an interface for allowing removal of target fluid amassed within the funnel when the apex of the funnel is submerged, such as through use of a pump.

Yet another aspect of the invention provides for a collector that is oriented in-fluid and subsurface for the purpose of collecting a fluid with a lower specific gravity suspended in a carrier fluid.

Another aspect of the invention provides a collector and method to orient the funnel of a collector below the surface of a body of carrier fluid with the larger end or base proximate and generally above the origin point of a target fluid of lower specific gravity dispersing into the carrier fluid so as to reduce its dispersal in the carrier fluid.

Another aspect of the invention provides for a collector constructed and arranged that takes advantage of the relative buoyancy characteristics of the target fluid having a lower specific gravity and the carrier fluid having a greater specific gravity.

Yet another aspect of the invention provides for deployment of a collector with the larger end or base of the funnel oriented towards a source or the target fluid of lower specific gravity dispersing into a carrier fluid.

Another aspect of the invention provides for a collector wherein the funnel is oriented in such a manner that the target fluid of lower specific gravity aggregates or amasses towards the smaller end or apex of the funnel and displaces the carrier fluid.

Another aspect of the invention provides for a collector with a funnel positioned below the surface of the carrier fluid and downstream from a source of a target fluid being released into the carrier fluid for collecting released the target fluid.

Another aspect of the invention provides for a collector with a funnel positioned below the surface of the carrier fluid, downstream from a source of a target fluid being released into the carrier fluid, and the larger end or base of the funnel facing the direction of flow, for collecting released the target fluid.

For a better understanding of the invention, however, reference should be made to the drawings which form a further part hereof, and to accompanying descriptive matter, in which there are illustrated and described specific examples in accordance with the invention.

### Construction

In the following description of the illustrated embodiments, reference is made to the accompanying drawings, which form a part hereof, and in which is shown by way of illustration several embodiments in which the invention may be practiced. It is to be understood that other embodiments may be utilized without departing from the spirit or scope of the present invention.

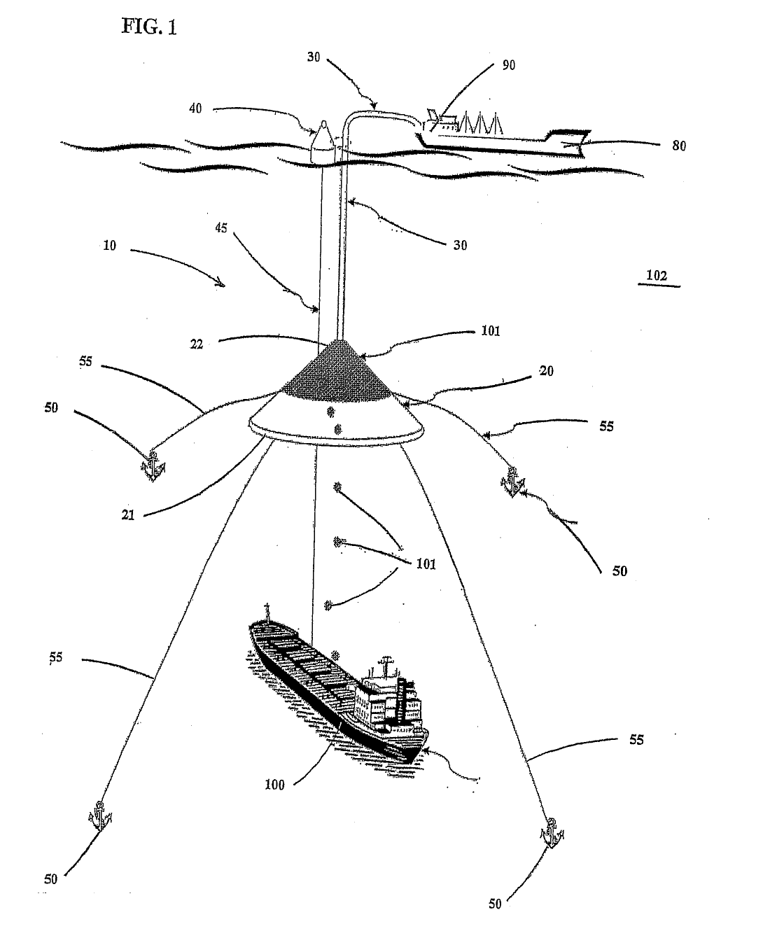

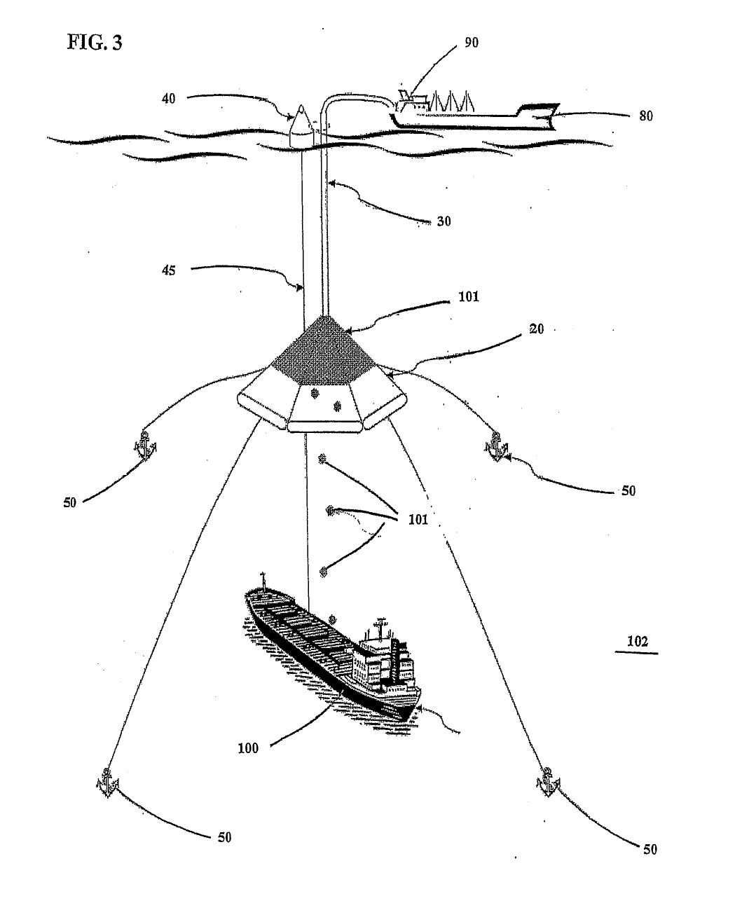

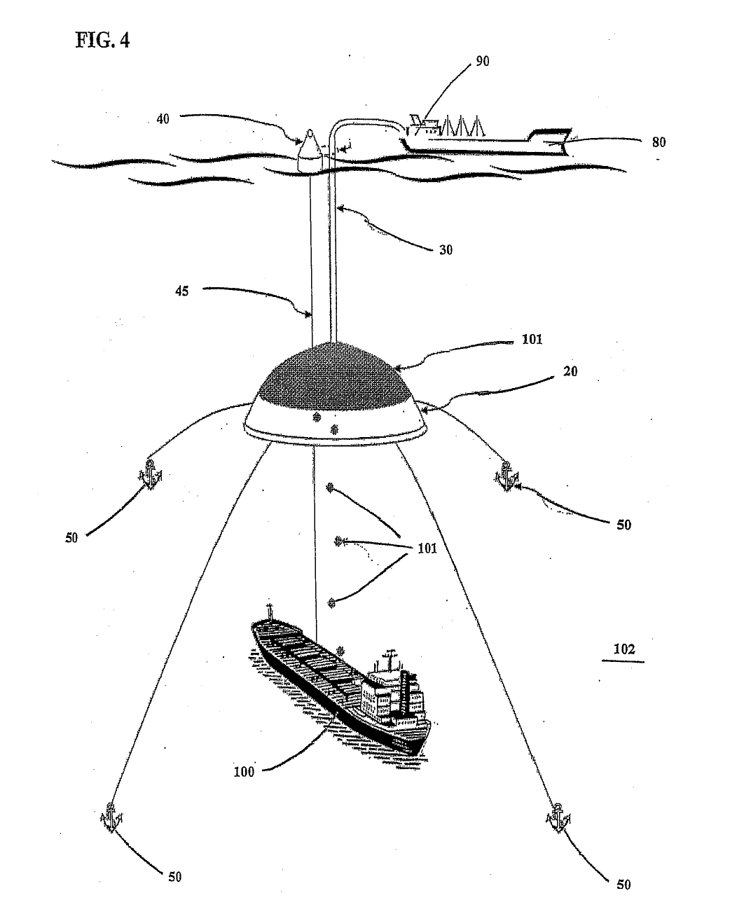

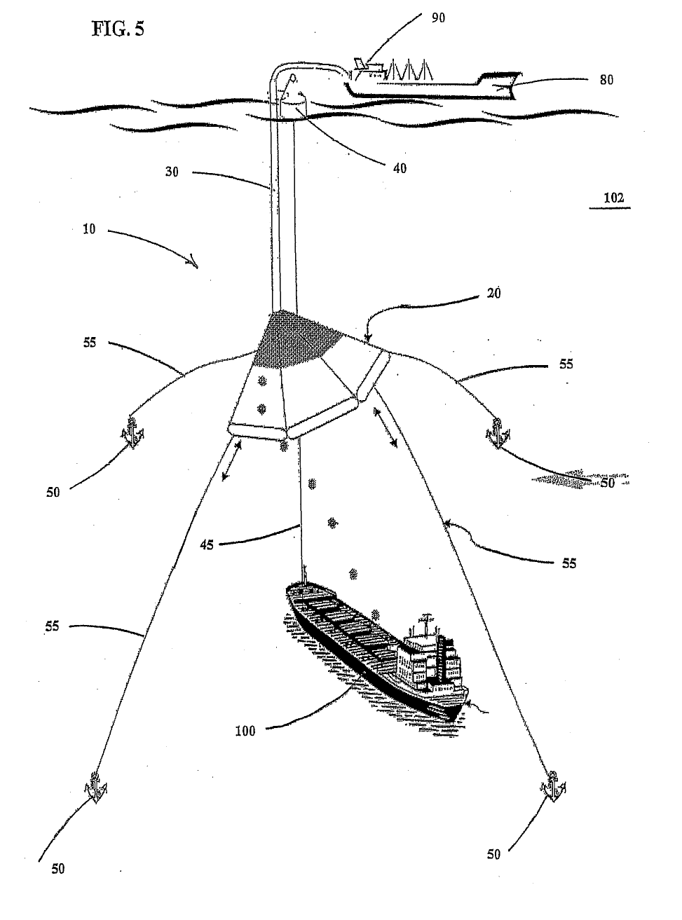

FIGS. 1 through 4 depict different embodiments of the Collector 10 deployed in a body of water 102 over a ship 100 applying Archimedes' principle for the in-fluid and sub-surface collection, separation, and removal of oil or other fluid 101 having a relative density less than that of fluid in which it is submerged. Referencing FIG. 1 to generally describe the apparatus, the Collector 10 includes a submerged inverted funnel 20, wherein the larger end 21 faces towards the source of target fluid 100. As shown in FIG. 5 the funnel 20 may be oriented to face the larger end 21 into any current causing vertical movement of the target fluid 101.

As utilized herein, including the claims, the term “funnel” means a hollow apparatus having a larger opening at one end and a smaller opening at the other end designed to catch and direct flow of a fluid from the larger end to the smaller end.

The target fluid 101 has a lesser relative density and thus is buoyant in the carrier fluid 102 and will therefore rise towards the surface of the carrier fluid 102. As the target fluid 101 rises, it is collected by the funnel 20 and displaces the heavier carrier fluid 102 at the top or smaller end 22 of the funnel 20 where it accumulates. The top 22 of the funnel 20 interfaces with an extraction pipe 30. The accumulated target fluid 101 may then be conveniently pumped by a pump 95 through the extraction pipe 30 to a reclamation vessel 80. The pump 90 is shown aboard reclamation vessel 80, but may also be conveniently carried on the funnel 20, on the extraction pipe 30, on the buoy 40 or a separate collection vessel (not shown).

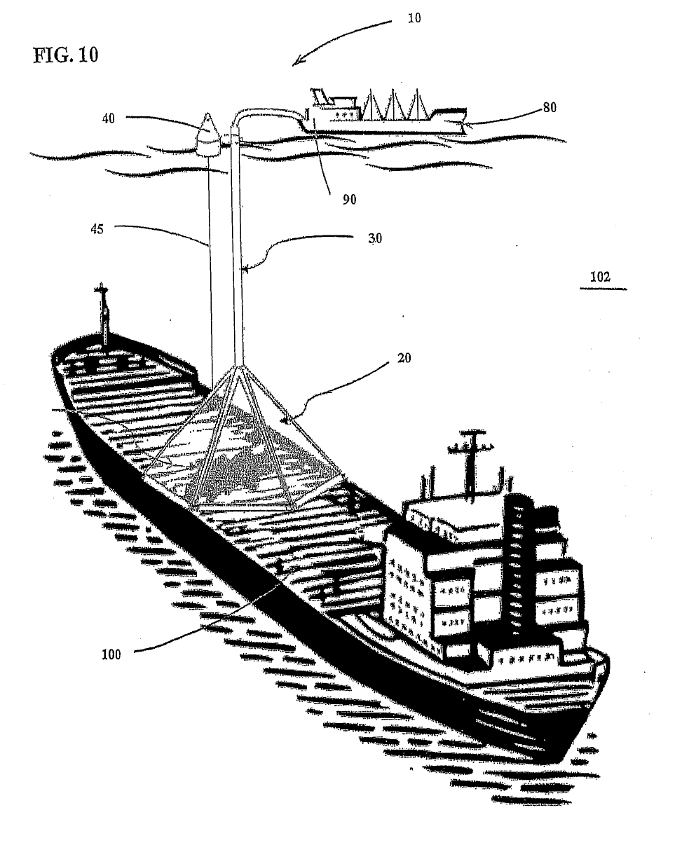

As shown in FIGS. 1-5, the funnel 20 may be submerged and maintained in the desired orientation over a source of target fluid 100 by way of anchors 50 attached to the larger end 21 of the funnel 20 by anchor tie lines 55. As shown in FIG. 10, another method for submerging and maintained the funnel 20 in the desired orientation over a source of target fluid 100 when the source of the target fluid 100 is a sunken ship 100 is magnetic solid ballast 60 around the periphery of the base 21 of the funnel 20 or mechanical grapples (not shown).

The vertical orientation of the funnel 20 may be controlled and maintained over the source of target fluid 100 by a flotation buoy 40 anchored at a predefined position on the surface of the carrier fluid 102 by a buoy anchor 49 and buoy tie line 45. The buoy 40 can also be attached to the smaller end 22 of the funnel 20 and/or extraction pipe 30 to assist in maintaining the desired inverted orientation and submerged depth of the funnel 20.

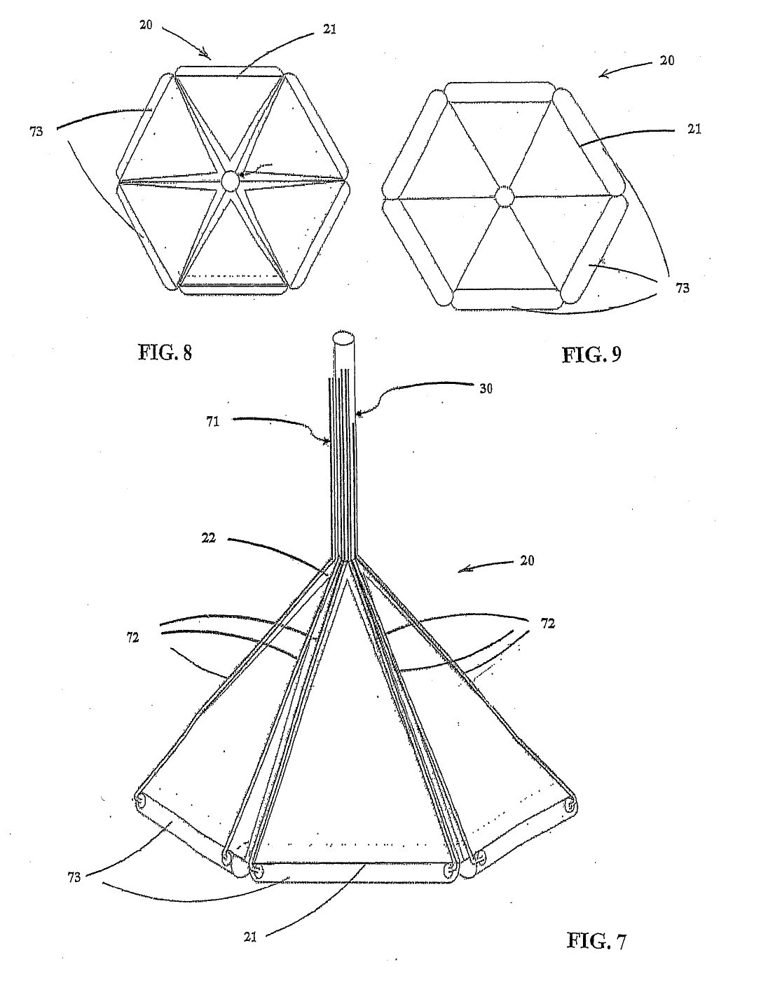

The funnel 20 may be constructed of rigid or flexible material such as a nylon fabric with or without special coatings for protections. Referring to FIGS. 7-9, in cases where the funnel 20 is constructed out of a fabric type material, the collector 10 may include an erection system 70 with a hub 71, spokes 72 and peripheral chambers 73 around the periphery of the larger end 21 of the funnel 20 capable of being filled with a fluid under sufficient pressure to erect the funnel 20. By controlling the type and amount of fluid employed in the erection system 70, the system can also be used as a ballast system to control the inverted orientation and submerged depth of the funnel 20 (i.e., filling the peripheral chambers 73 with a fluid having a specific gravity greater than the carrier fluid 101 assists in maintaining the inverted orientation of the funnel 20 and assists in maintaining a desired submerged depth of the funnel 20.

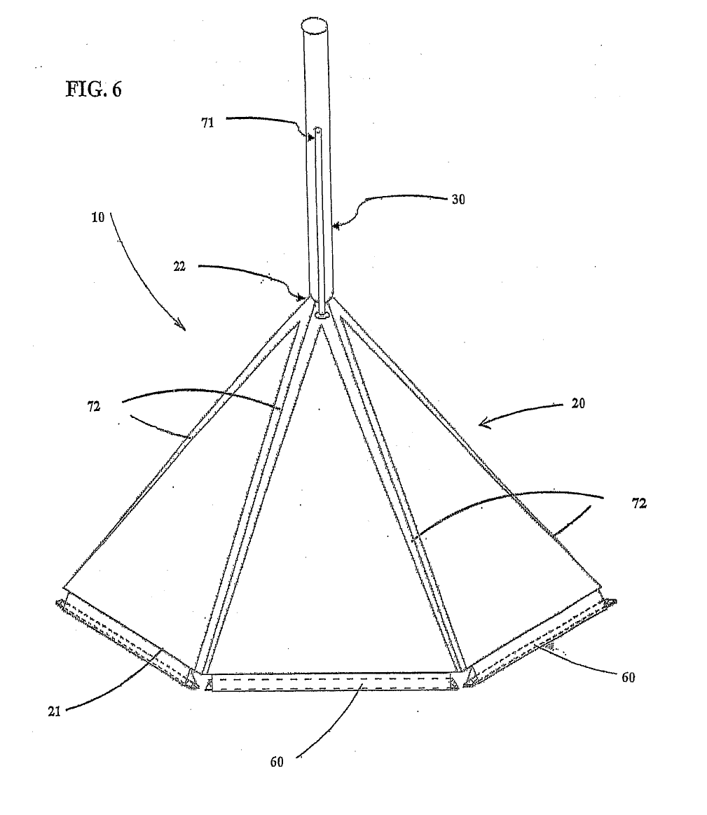

As shown in FIG. 6, solid ballast 60 may also be provided around the periphery of the larger end 21 of the funnel 20.

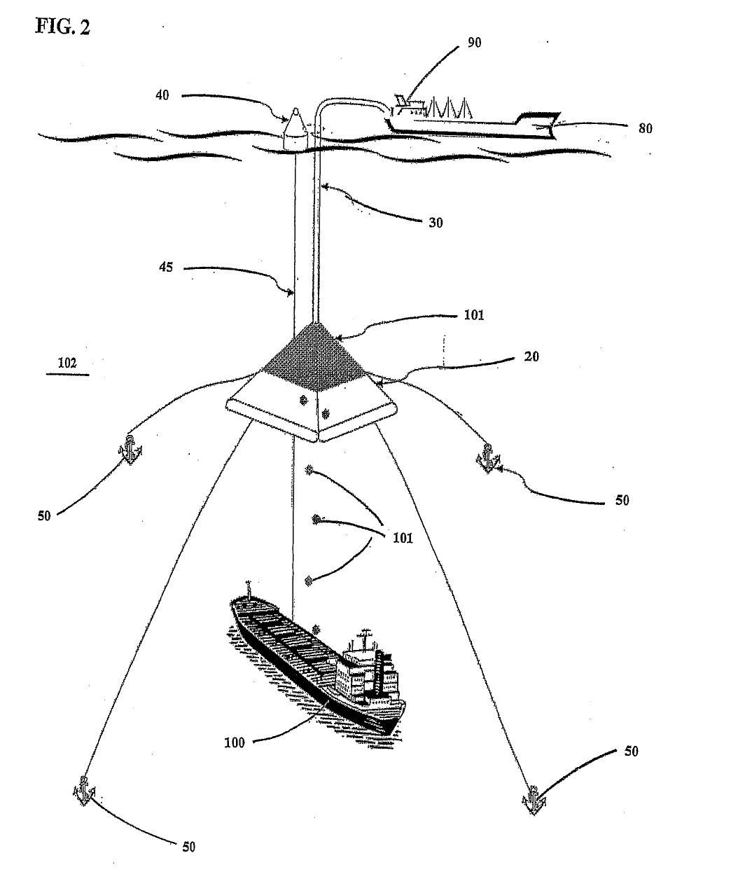

One option for controlling orientation of the funnel 20 in a carrier fluid 102 is generally shown in FIG. 5. Such orientation control is of particular importance when the carrier fluid 102 is subject to flow by way of tides, currents and eddies. As shown in FIG. 2, the length of each anchor tie line 55 can be independently controlled relative to the length of the other anchor tie lines 55 to angle the base 21 of the funnel 20, typically for purposes of facing the base 21 towards the flow of the carrier fluid 102. However, it is appreciated by one skilled in the art that a multiplicity of anchors and cables may be used to provide control of the orientation and stability of the funnel 20. It is further appreciated by those skilled in the art that there are various means readily available to provide anchorage of the funnel 20 and controlling the lengths of the anchor tie lines 55 for orienting the funnel 20.

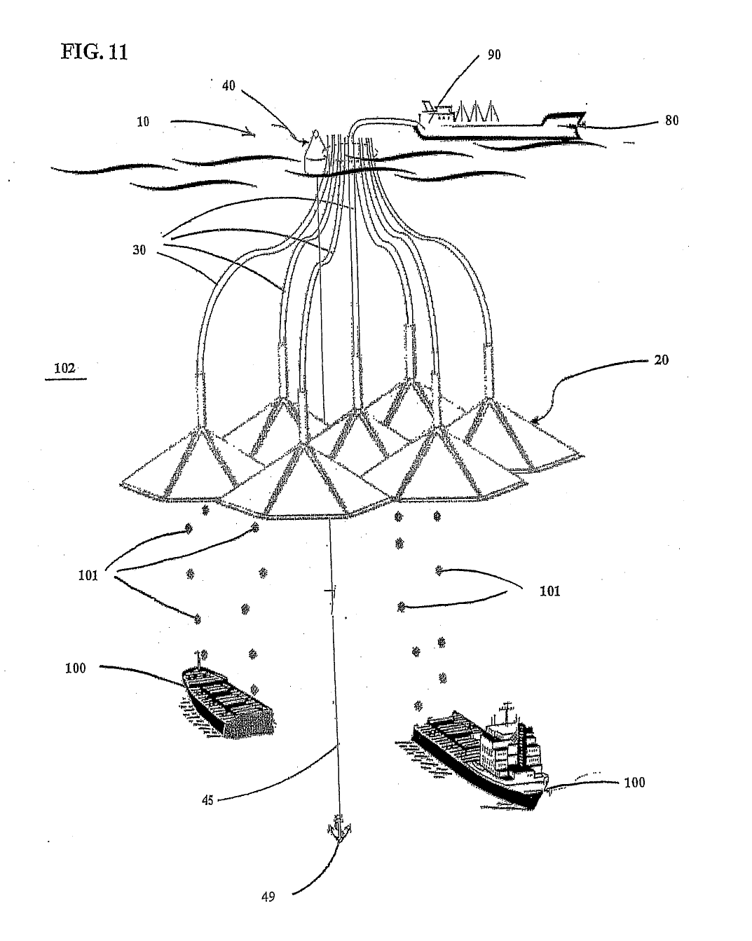

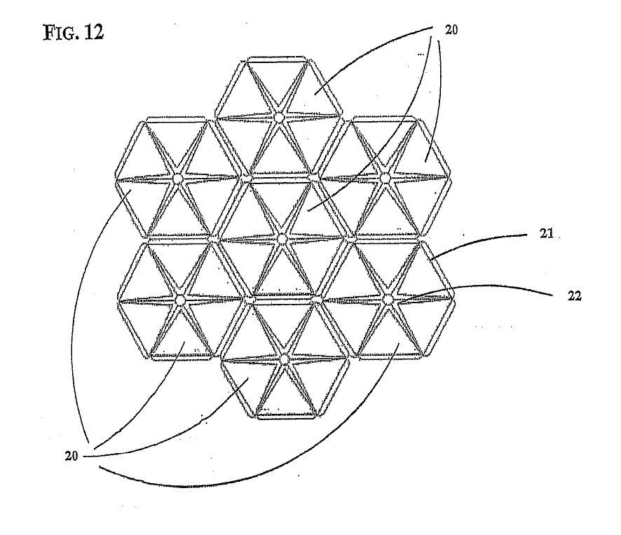

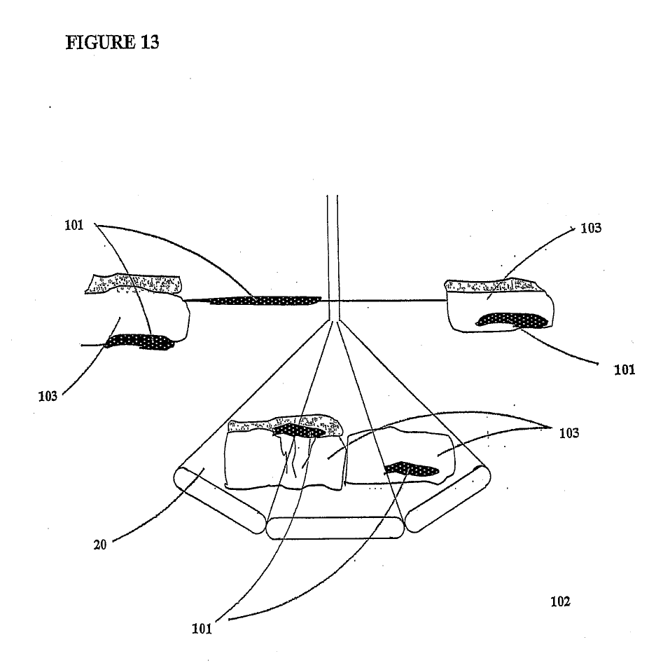

FIGS. 11 and 12 illustrate the ability to deploy multiple funnels 20, connected in a tight array, so as to cover a larger area for the collection of a target fluid 101 from multiple sources 100 and/or from a single source 100 when prevailing currents tend to change in strength and direction.

I claim:

1. An apparatus for collecting a target fluid submerged in a carrier fluid when the specific gravity of the target fluid is lower that the specific gravity of the carrier fluid and the target fluid is essentially immiscible with the carrier fluid, comprising:
(a) a funnel having a slant height, a larger end and a smaller end,
(b) a system effective for achieving submersion of a majority of the slant height of the funnel within the carrier fluid, and
(c) a pump in fluid communication with the interior volume of the funnel proximate the smaller end of the funnel for pumping fluid collected at the smaller end of the funnel.

2. The apparatus of claim 1 further comprising a flotation device connected to the funnel proximate the smaller end of the funnel.

3. The apparatus of claim 1 wherein the target fluid is a hydrocarbon and the carrier fluid is water.

4. The apparatus of claim 1 wherein the target fluid is crude oil and the carrier fluid is salt water.

5. The apparatus of claim 1 wherein the funnel defines a funnel opening at the larger end of the funnel having an area of between about 100 ft² to about 100,000 ft².

6. The apparatus of claim 5 wherein the funnel has an interior slant angle of between about 30° and about 70°.

7. The apparatus of claim 5 wherein the funnel is constructed from a supple material capable of being nondestructively folded and unfolded for compact transport and storage.

8. The apparatus of claim 5 wherein the funnel is constructed from a set of modular panels.

9. The apparatus of claim 5 wherein the funnel is constructed from a set of hingedly interconnected panels configured and arranged to permit pivoting of the panels as between a flattened storage configuration and a funnel-shaped use configuration.

10. The apparatus of claim 5 wherein the submersion system comprises ballast configured and arranged to weight down the larger end of the funnel.

11. The apparatus of claim 10 wherein the ballast is retained within one or more compartments positioned along the periphery of the funnel proximate the larger end.

12. The apparatus of claim 10 wherein the ballast is magnetized.

13. The apparatus of claim 5 wherein the submersion system comprises at least three anchors, each attached to the funnel proximate the larger end of the funnel by a line.

14. A method for collecting a target fluid submerged in a carrier fluid when the carrier fluid defines a an upper surface, the specific gravity of the target fluid is lower that the specific gravity of the carrier fluid, and the target fluid is essentially immiscible with the carrier fluid, comprising the step of positioning a funnel between the submerged target fluid and the upper surface of the carrier fluid so as to catch and direct an upward flow of the target fluid towards the smaller end of the funnel before the target fluid reaches the upper surface of the carrier fluid.

15. The method of claim 14 further comprising the step of pumping the target fluid collected at the smaller end of the funnel into a storage container.

16. The method of claim 14 wherein the target fluid is a hydrocarbon and the carrier fluid is water.

17. The method of claim 14 wherein the target fluid is crude oil aboard a sunken transport ship in the ocean and the carrier fluid is salt water.

18. The method of claim 14 wherein the funnel defines a funnel opening at the larger end of the funnel having an area of between about 100 ft² to about 100,000 ft².

19. The method of claim 18 wherein the funnel has an interior slant angle of between about 30° and about 70°.

20. The method of claim 18 wherein the funnel is constructed from a supple material capable of being nondestructively folded and unfolded for compact transport and storage.

21. The method of claim 18 wherein the funnel is constructed from a set of modular panels.

22. The method of claim 18 wherein the funnel is constructed from a set of hingedly interconnected panels configured and arranged to permit pivoting of the panels as between a flattened storage configuration and a funnel-shaped use configuration.

23. The method of claim 18 wherein the funnel is held in position between the submerged target fluid and the upper surface of the carrier fluid by ballast configured and arranged to weight down the larger end of the funnel.

24. The method of claim 23 wherein the ballast is retained within one or more compartments positioned along the periphery of the funnel proximate the larger end

25. The method of claim 17 wherein the funnel is held in position between the submerged target fluid and the upper surface of the carrier fluid by magnetic attachment of the larger end of the funnel to the transport ship using magnets on the funnel.

26. The method of claim 18 wherein the funnel is held in position between the submerged target fluid and the upper surface of the carrier fluid by at least three anchors, each attached to the funnel proximate the larger end of the funnel by a line.
